(19) United States
(12) Patent Application Publication
(10) Pub. No.: US 2012/0015267 A1
(43) Pub. Date: Jan. 19, 2012

(54) FUEL CELL SYSTEM, CONTROL METHOD FOR THE FUEL CELL SYSTEM, AND ELECTRIC VEHICLE EQUIPPED WITH THE FUEL CELL SYSTEM

(75) Inventors: Michio Yoshida, Miyoshi-shi (JP); Atsushi Imai, Gamagori-shi (JP); Tomoya Ogawa, Toyota-shi (JP)

(73) Assignee: TOYOTA JIDOSHA KABUSHIKI KAISHA, Toyota-shi (JP)

(21) Appl. No.: 13/258,172

(22) PCT Filed: Mar. 18, 2010
(86) PCT No.: PCT/IB2010/000584

§ 371 Date: Sep. 21, 2011

(30) Foreign Application Priority Data
Mar. 31, 2009 (JP) 2009-085111

(51) Int. Cl. H01M 8/04

(52) U.S. Cl. 429/429

(57) ABSTRACT

A fuel cell system includes a fuel cell that has a plurality of fuel unit cells, and a control portion that controls voltage of the fuel cell. The control portion has: start means for starting the fuel cell by raising the voltage of the fuel cell from a starting voltage to a high-potential-avoiding voltage that is lower than an open-circuit voltage; and command means for further raising the voltage of the fuel cell beyond the high-potential-avoiding voltage if cell voltage of at least one of the plurality of fuel unit cells is lower than or equal to a certain voltage after a certain time elapses after the voltage of the fuel cell is raised to the high-potential-avoiding voltage.

### BACKGROUND OF THE INVENTION

1. Field of the Invention

The invention relates to fuel cell system, a control method for the fuel cell system, and a control that is performed on an electric vehicle equipped with the fuel cell system, at the time of activating the electric vehicle.

2. Description of the Related Art

Practical application of a fuel cell that supplies hydrogen as a fuel gas to a fuel electrode, and that supplies air as an oxidant gas to an oxidant electrode, and that generates electricity through an electrochemical reaction between hydrogen and oxygen in the air while producing water on an oxidant electrode is now being considered.

In such a fuel cell, if at the time of start of operation, the pressure of hydrogen supplied to the fuel electrode and the pressure of air supplied to the oxidant electrode are about equal to the respective pressures occurring during ordinary operation, it sometimes happens that hydrogen gas and air are unevenly distributed in the fuel electrode and the oxidant electrode, respectively, and the electrodes are degraded by electrochemical reaction caused by the uneven distribution of these gases. Japanese Patent Application Publication No. 2007-26891 (JP-A-2007-26891) discloses a method of preventing the degradation of the electrodes of a fuel cell by causing the pressures of hydrogen and air supplied to the fuel electrode and the oxidant electrode, respectively, at the time of start of operation of the fuel cell to be higher than the ordinary supplied pressures of these gases.

However, if hydrogen gas and air are supplied at high pressure to a fuel cell when the fuel cell starts operation, it sometimes happen that the rate of rise of the voltage of the fuel cell becomes large so that the voltage of the fuel cell overshoots its upper-limit voltage. In conjunction with this problem, Japanese Patent Application Publication No. 2007-26891 (JP-A-2007-26891) discloses a method in which when hydrogen gas and air are supplied, at the time of starting a fuel cell, at pressures that are higher than their pressures given during ordinary power generation, output electric power is extracted from the fuel cell, and is put out to a vehicle driving motor, resistors, etc., provided that the voltage of the fuel cell reaches a predetermined voltage that is lower than the upper-limit voltage.

However, if during ordinary operation of the fuel cell, one or more of a plurality of fuel unit cells that constitute the fuel cell exhibit low voltage as a result of continuation of electricity generation, a control of attempting recovery of the low-voltage fuel unit cells is performed. However, if one or more of the fuel unit cells that constitute the fuel cell exhibit low voltage when the fuel cell is started, the starting of the fuel cell is finished and an ordinary operation is entered without providing an opportunity of attempting the recovery of the low-voltage fuel unit cells. In that case, durability or the like of the fuel cell is sometimes adversely affected.

### SUMMARY OF THE INVENTION

Accordingly, the invention provides a fuel cell system that is able to start without adversely affecting the durability or the like of the fuel cell when the fuel cell is started, and also provides a control method for the foregoing fuel cell system, and an electric vehicle equipped with the fuel cell system.

A fuel cell system in accordance with a first aspect of the invention includes a fuel cell that has a plurality of fuel unit cells that generate electricity through an electrochemical reaction between a fuel gas and an oxidant gas, and a control portion that controls voltage of the fuel cell. The control portion has: start means for starting the fuel cell by raising the voltage of the fuel cell from a starting voltage to a high-potential-avoiding voltage that is lower than an open-circuit voltage; and command means for further raising the voltage of the fuel cell beyond the high-potential-avoiding voltage if cell voltage of at least one of the plurality of fuel unit cells is lower than or equal to a certain voltage after a certain time elapses after the voltage of the fuel cell is raised to the high-potential-avoiding voltage.

Besides, in the fuel cell system in accordance with the first aspect, the command means may raise the voltage of the fuel cell to the open-circuit voltage if the cell voltage of at least one of the plurality of fuel unit cells is lower than or equal to the certain voltage after the certain time elapses after the voltage of the fuel cell is raised to the high-potential-avoiding voltage.

Besides, in the fuel cell system in accordance with the first aspect, if the cell voltage of at least one fuel unit cell of the plurality of fuel unit cells is lower than or equal to the certain voltage after the certain time elapses after the voltage of the fuel cell is raised to the high-potential-avoiding voltage, the command means may raise the voltage of the fuel cell beyond the high-potential-avoiding voltage according to a difference between the certain voltage and the cell voltage of the at least one fuel unit cell.

An electric vehicle in accordance with a second aspect of the invention is equipped with the fuel cell system in accordance with the first aspect.

A control method for a fuel cell system in accordance with a third aspect of the invention is a control method for a fuel cell system that includes a fuel cell that has a plurality of fuel unit cells that generate electricity through an electrochemical reaction between a fuel gas and an oxidant gas. The control method includes: starting the fuel cell by raising voltage of the fuel cell from a starting voltage to a high-potential-avoiding voltage that is lower than an open-circuit voltage; detecting cell voltage of the plurality of fuel unit cells after a certain time elapses after the voltage of the fuel cell is raised to the high-potential-avoiding voltage; determining whether or not the detected cell voltage of at least one of the plurality of fuel unit cells is lower than or equal to a certain voltage; and further raising the voltage of the fuel cell beyond the high-potential-avoiding voltage if it is determined that the cell voltage of at least one of the plurality of fuel unit cells is lower than or equal to the certain voltage.

Besides, in the control method in accordance with the third aspect, the voltage of the fuel cell may be raised to an open-circuit voltage that is higher than the high-potential-avoiding voltage, if it is determined that the cell voltage of at least one of the plurality of fuel unit cells is lower than or equal to the certain voltage.

Besides, in the control method in accordance with the third aspect, if it is determined that the cell voltage of at least one fuel unit cell of the plurality of fuel unit cells is lower than or equal to the certain voltage, the voltage of the fuel cell is further raised beyond the high-potential-avoiding voltage according to a difference between the certain voltage and the cell voltage of the at least one fuel unit cell.

According to the invention, the fuel cell system can be started without adversely affecting the durability of the fuel cell, or the like, at the time of starting the fuel cell.

### BRIEF DESCRIPTION OF THE DRAWINGS

The foregoing and/or further objects, features and advantages of the invention will become more apparent from the following description of example embodiments with reference to the accompanying drawings, in which like numerals are used to represent like elements and wherein:

FIG. 1 is a system diagram of a fuel cell system in an embodiment of the invention;

FIG. 2 is a graph showing an example of a voltage control performed when the fuel cell system in accordance with the embodiment of the invention is started; and

FIG. 3 is a graph showing another example of the voltage control performed when the fuel cell system in accordance with the embodiment of the invention is started.

### DETAILED DESCRIPTION OF EMBODIMENTS

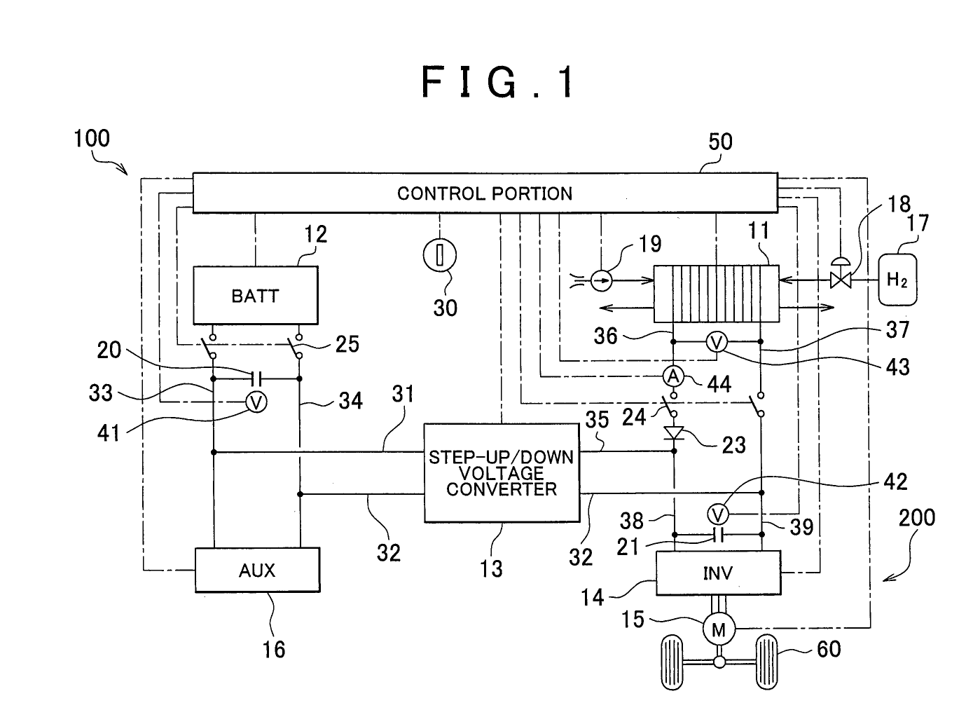

As shown in FIG. 1, a fuel cell system 100 mounted in an electric vehicle 200 includes a chargeable and dischargeable secondary cell 12, a step-up/down voltage converter 13 that raises or lowers the voltage of the secondary cell 12, an inverter 14 that converts direct-current electric power of the step-up/down voltage converter 13 into alternating-current electric power, and supplies the electric power to a traction motor 15, and a fuel cell 11.

The secondary cell 12 is constructed of a chargeable and dischargeable lithium-ion battery, or the like. The voltage of the secondary cell 12 in this embodiment is lower than the drive voltage of the traction motor 15. However, the voltage of the secondary cell is not limited so, but may also be a voltage that is equivalent to or higher than the drive voltage of the traction motor. The step-up/down voltage converter 13 includes a plurality of switching elements, and converts a low voltage supplied from the secondary cell 12 to a high voltage for driving the traction motor, by the on/off operations of the switching elements. The step-up/down voltage converter 13 is a non-insulated bidirectional DC/DC converter whose reference electrical path 32 is connected to both a minus-side electrical path 34 of the secondary cell 12 and a minus-side electrical path 39 of the inverter 14, and whose primary-side electrical path 31 is connected to a plus-side electrical path 33 of the secondary cell 12, and whose secondary-side electrical path 35 is connected to a plus-side electrical path 38 of the inverter 14. Besides, the plus-side electrical path 33 and the minus-side electrical path 34 of the secondary cell 12 are each provided with a system relay 25 that turns on and off the connection between the secondary cell 12 and a load system.

The fuel cell 11 has a plurality of fuel unit cells that are supplied with hydrogen gas, which is a fuel gas, and with air, which is an oxidant gas, and that generate electricity through an electrochemical reaction between the hydrogen gas and the oxygen in the air. In the fuel cell 11, the hydrogen gas is supplied from a high-pressure hydrogen tank 17 to a fuel electrode (anode) via a hydrogen supply valve 18, and the air is supplied to an oxidant electrode (cathode) by an air compressor 19. A plus-side electrical path 36 of the fuel cell 11 is connected to the secondary-side electrical path 35 of the step-up/down voltage converter 13 via an FC relay 24 and a blocking diode 23. A minus-side electrical path 37 of the fuel cell 11 is connected to the reference electrical path 32 of the step-up/down voltage converter 13 via another FC relay 24. The secondary-side electrical path 35 of the step-up/down voltage converter 13 is connected to the plus-side electrical path 38 of the inverter 14, and the reference electrical path 32 of the step-up/down voltage converter 13 is connected to the minus-side electrical path 39 of the inverter 14. The plus-side electrical path 36 and the minus-side electrical path 37 of the fuel cell 11 are connected to the plus-side electrical path 38 and the minus-side electrical path 39, respectively, of the inverter 14, via the FC relays 24. The FC relays 24 turn on and off the connection between the load system and the fuel cell 11. When the FC relays 24 are closed, the fuel cell 11 is connected to the secondary side of the step-up/down voltage converter 13, so that the electric power generated by the fuel cell 11 is supplied together with the secondary-side electric power of the secondary cell 12 obtained by raising the voltage of the primary-side electric power of the secondary cell 12, to the inverter, which thereby drives the traction motor 15 that rotates wheels 60. At this time, the voltage of the fuel cell 11 becomes equal to the output voltage of the step-up/down voltage converter 13 and to the input voltage of the inverter 14. Besides, the drive electric power for the air compressor 19, and accessories 16 of the fuel cell 11, such as a cooling water pump, a hydrogen pump, etc., is basically provided by the voltage that is generated by the fuel cell 11. If the fuel cell 11 cannot generate the required electric power, the secondary cell 12 is used as a complement source.

A primary-side capacitor 20 that smoothes the primary-side voltage is connected between the plus-side electrical path 33 and the minus-side electrical path 34 of the secondary cell 12. The primary-side capacitor 20 is provided with a voltage sensor 41 that detects the voltage between the two ends of the primary-side capacitor 20. Besides, a secondary-side capacitor 21 that smoothes the secondary-side voltage is provided between the plus-side electrical path 38 and the minus-side electrical path 39 of the inverter 14. The secondary-side capacitor 21 is provided with a voltage sensor 42 that detects the voltage between the two ends of the secondary-side capacitor 21. The voltage across the primary-side capacitor 20 is a primary-side voltage V_{L} that is the input voltage of the step-up/down voltage converter 13, and the voltage across the secondary-side capacitor 21 is a secondary-side voltage V_{H} that is the output voltage of the step-up/down voltage converter 13. Besides, a voltage sensor 43 that detects the voltage of the fuel cell 11 is provided between the plus-side electrical path 36 and the minus-side electrical path 37 of the fuel cell 11. The voltage sensor 43 also detects the cell voltage of each of the fuel unit cells that constitute the fuel cell 11. Besides, the plus-side electrical path 36 of the fuel cell 11 is provided with an electric current sensor 44 that detects the output current of the fuel cell 11.

A control portion 50 is a computer that contains a CPU that performs signal processing, and a storage portion that stores programs and control data. The fuel cell 11, the air compressor 19, the hydrogen supply valve 18, the step-up/down voltage converter 13, the inverter 14, the traction motor 15, the accessories 16, the FC relays 24, and the system relays 25 are connected to the control portion 50, and are constructed so as to operate according to commands from the control portion 50. Besides, the secondary cell 12, the voltage sensors 41 to 43, and the electric current sensor 44 are separately connected to the control portion 50, and are constructed so that the state of the secondary cell 12, and detection signals of the voltage sensors 41 to 43 and the electric current sensor 44 are input to the control portion 50. The electric vehicle 200 is provided with an ignition key 30 that is a switch for starting and stopping the fuel cell system 100. The ignition key 30 is connected to the control portion 50, and is constructed so that an on/off-signal of the ignition key 30 is input to the control portion 50.

In the fuel cell system 100 having two kinds of electric power sources as described above, the output electric powers of the two cells 11 and 12 are controlled on the basis of a distribution computation for distributing the electric power needed for driving the traction motor 15 between the output electric power of the secondary cell 12 and the output electric power of the fuel cell 11 during ordinary operation. The electric power distribution computation is performed on the basis of the output current-voltage characteristic of the fuel cell and the output current-voltage characteristic of the secondary cell. However, after the fuel cell 11 is started, it takes a time before the voltage of the fuel cell 11 rises up to the operation voltage and therefore electric power can be produced from the fuel cell 11. Hence, in the electric vehicle 200 equipped with the secondary cell 12 and the fuel cell 11, during the period from when the ignition key 30 is turned on to start up the electric vehicle 200 to when it becomes possible to produce electric power from the fuel cell 11, the electric power distribution computation is not performed but the output electric power command value of the fuel cell 11 is set at zero, and the electric power from the secondary cell 12 is used to drive the electric vehicle 200. Then, when the starting of the fuel cell 11 is completed, the operation shifts to an ordinary operation during which the electric power distribution computation is performed.

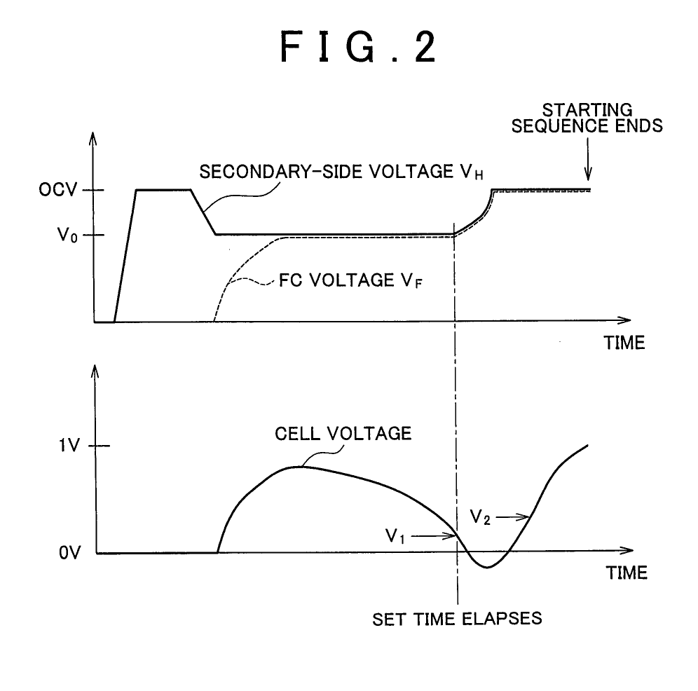

An operation of the fuel cell system 100 in accordance with the embodiment will be described. FIG. 2 is a diagram showing an example of a voltage control performed when the fuel cell system in accordance with the embodiment is started. In an upper section of FIG. 2, changes in the voltage of the fuel cell are shown, with a solid line showing secondary-side voltage V_{H} that is the command voltage of the step-up/down voltage converter 13, and a dotted line showing FC voltage V_{F} that is the voltage (total voltage) of the fuel cell 11. A lower section of FIG. 2 shows an example of changes in the voltage of a fuel unit cell in the case where the cell voltage thereof becomes low.

When a driver, that is, an operating person, turns on the ignition key 30, the on-signal from the ignition key 30 is input to the control portion 50. Then, the control portion 50 closes the system relays 25 to connect the secondary cell 12 to the system. After the secondary cell 12 is connected to the system, the primary-side capacitor 20 is charged by the electric power supplied from the secondary cell 12. After the primary-side capacitor is charged, the control portion 50 starts a voltage-raising operation of the step-up/down voltage converter 13 to charge the secondary-side capacitor 21, whereby the secondary-side voltage V_{H} detected by the voltage sensor 42 is raised to the open-circuit voltage OCV (as shown by the solid line in the upper section of FIG. 2). Incidentally, when the secondary-side voltage V_{H} reaches the open-circuit voltage OCV, the charging of the secondary-side capacitor 12 is completed, so that electric power can be supplied from the secondary cell 12. Therefore, when the driver depresses the accelerator pedal, electric power from the secondary cell 12 is supplied to the traction motor 15 according to the required electric power, so that the wheels 60 are correspondingly rotated. Thus, the electric vehicle 200 starts to move.

The control portion 50 outputs a command to pressurize a hydrogen system. Due to this command, the hydrogen supply valve 18 opens, so that hydrogen starts to be supplied from the hydrogen tank 17 to the fuel cell 11. When hydrogen is supplied, the pressure at the fuel electrode of the fuel cell 11 rises. However, since the oxidant electrode has not been supplied with air, the electrochemical reaction does not occur within the fuel cell 11, and therefore the fuel cell 11 does not generate electricity. Thus, at this time, the FC voltage V_{F} of the fuel cell 11 is zero, as is the case with the starting voltage of the fuel cell 11. Incidentally, after the pressurization of the hydrogen system starts, hydrogen leakage detection may be performed.

After the pressurization of the hydrogen system starts, the FC relay 24 is closed to connect the fuel cell 11 to the step-up/down voltage converter 13 and to the inverter 14. Then, the control portion 50 starts to lower the secondary-side voltage V_{H} from the open-circuit voltage OCV to a high-potential-avoiding voltage V₀ as shown by the solid line in the upper section of FIG. 2, and also outputs a command to start the air compressor 19. Due to this command, the air compressor 19 starts, so that air starts to be supplied to the fuel cell 11. It is to be noted herein that the high-potential-avoiding voltage V₀ means a pre-determined operation voltage that is less than the open-circuit voltage OCV, and can be generated by the fuel cell 11, so that durability of the fuel cell 11 will be certainly maintained.

After the air compressor 19 is started and therefore air begins to be supplied to the fuel cell 11, the electrochemical reaction between the hydrogen and the oxygen in the air begins within the fuel cell 11, so that the FC voltage V_{F} of the fuel cell 11 detected by the voltage sensor 43 gradually rises from the starting voltage, that is, zero, as shown by the dotted line in the upper section of FIG. 2. Then, the FC voltage V_{F} of the fuel cell 11 reaches the high-potential-avoiding voltage V₀. At this time, since the secondary-side voltage, which is the output voltage of the step-up/down voltage converter 13, is held at the high-potential-avoiding voltage V₀, the FC voltage V_{F} of the fuel cell is also held at the high-potential-avoiding voltage V₀, and does not rise to the open-circuit voltage OCV. Incidentally, while the FC voltage V_{F} of the fuel cell 11 is rising, the hydrogen and the air supplied to the fuel cell 11 do not flow due to the blockage by a blocking diode 23.

The control portion 50 checks whether or not the fuel unit cells that constitute the fuel cell 11 are normally operating, after a certain time elapses after the FC voltage V_{F} of the fuel cell 11 has risen. If one or more of the fuel unit cells undergo declines in the cell voltage as shown in FIG. 2, the FC voltage V_{F} of the fuel cell 11 reaches the high-potential-avoiding voltage V₀. Then, when a fuel unit cell becomes negative in potential (has reversal potential), the fuel unit cell degrades and breaks. Therefore, in order to avoid this, it is necessary to provide an opportunity of attempting the voltage recovery of a low-voltage fuel unit cell, when the fuel cell 11 is started.

Concretely, the control portion 50 determines whether or not the cell voltage of a fuel unit cell detected by the voltage sensor 43 is lower than or equal to a certain voltage (V₁ shown in the lower section of FIG. 2) that is pre-set in the control portion 50, after a certain time elapses after the FC voltage V_{F} of the fuel cell 11 has risen. During a state immediately after the fuel cell 11 is started, for example, a state which is after the pressurization of the hydrogen system is started, and during which the air compressor 19 has not been started, or the like, it sometimes happens that the cell voltage of a fuel unit cell is extremely low although the FC voltage V_{F} of the fuel cell 11 is high. However, in such a state, the determination as to whether or not the fuel unit cell is normally operating is not performed. Therefore, it is necessary to determine whether or not the cell voltage of the fuel unit cell detected by the voltage sensor 43 is lower than or equal to the certain voltage (V₁) pre-set in the control portion 50, after a certain time elapses after the FC voltage V_{F} of the fuel cell 11 has risen, that is, after a certain time elapses following the pressurization of the hydrogen system and the starting of the air 25, compressor 19. As for the setting of the certain time, it suffices to appropriately set it by an operation of the fuel cell system. For example, in a fuel cell system that performs a sequence of the supply of hydrogen, the hydrogen leakage detection, the supply of oxygen, etc., in that order, it suffices that the certain time is appropriately set at a time required from when hydrogen leakage is detected, that is, from when the supply of oxygen is started, to when the FC voltage V_{F} of the fuel cell 11 reaches the high-potential-avoiding voltage V₀. Alternatively, the point of elapse of the foregoing certain time may also be appropriately set at several ten seconds after the FC voltage V_{F} of the fuel cell 11 reaches the high-potential-avoiding voltage V₀.

In the case where at least one of the fuel unit cells is lower than or equal to a certain voltage, the control portion 50 raises the secondary-side voltage V_{H} from the high-potential-avoiding voltage V₀ to the open-circuit voltage OCV, thereby raising the FC voltage V_{F} of the fuel cell 11 to the open-circuit voltage OCV. The fuel cell 11 has a characteristic that as the FC voltage V_{F} rises to the open-circuit voltage OCV, the output current of the fuel cell 11 gradually decreases, and that when the FC voltage V_{F} reaches the open-circuit voltage OCV, the output current of the fuel cell 11 becomes zero. Specifically, in the case where the cell voltage of a fuel unit cell is less than or equal to a certain voltage when the fuel cell 11 is started, recovery of the cell voltage of that low-voltage fuel unit cell is attempted by raising the FC voltage V_{F} of the fuel cell 11 to the open-circuit voltage OCV and therefore restricting the output current of the fuel cell 11, prior to the shift to the ordinary operation.

At the time of starting the fuel cell 11, the control portion 50, after raising the FC voltage V_{F} to the open-circuit voltage OCV, assumes that the starting of the fuel cell 11 has been completed, and shifts to ordinary operation, while keeping the FC voltage V_{F} of the fuel cell 11 raised at the open-circuit voltage OCV, regardless of whether the fuel unit cell is recovered. Incidentally, this operation is not restrictive. For example, when the cell voltage of a low-voltage fuel unit cell becomes equal to or higher than a certain voltage (V₂), the control portion 50 may lower the FC voltage V_{F} of the fuel cell 11 to the high-potential-avoiding voltage V₀, and then may shift to ordinary operation, assuming that the starting of the fuel cell 11 has been completed. The foregoing certain voltages (V₁ and V₂) may be appropriately set. However, it is preferable that the certain voltages be set at values (e.g., V₁=0.1, and V₂=0.3) such that if the cell voltage of a fuel unit cell is lower than or equal to the certain voltage, there is risk that the fuel unit cell may have reversal potential.

On the other hand, if the cell voltage of a fuel unit cell is higher than or equal to the certain voltage (V₁) after a certain time elapses after the FC voltage V_{F} of the fuel cell 11 has risen, the control portion 50 determines that the fuel unit cell does not have abnormality, and shifts to ordinary operation, assuming that the starting of the fuel cell 11 has been completed.

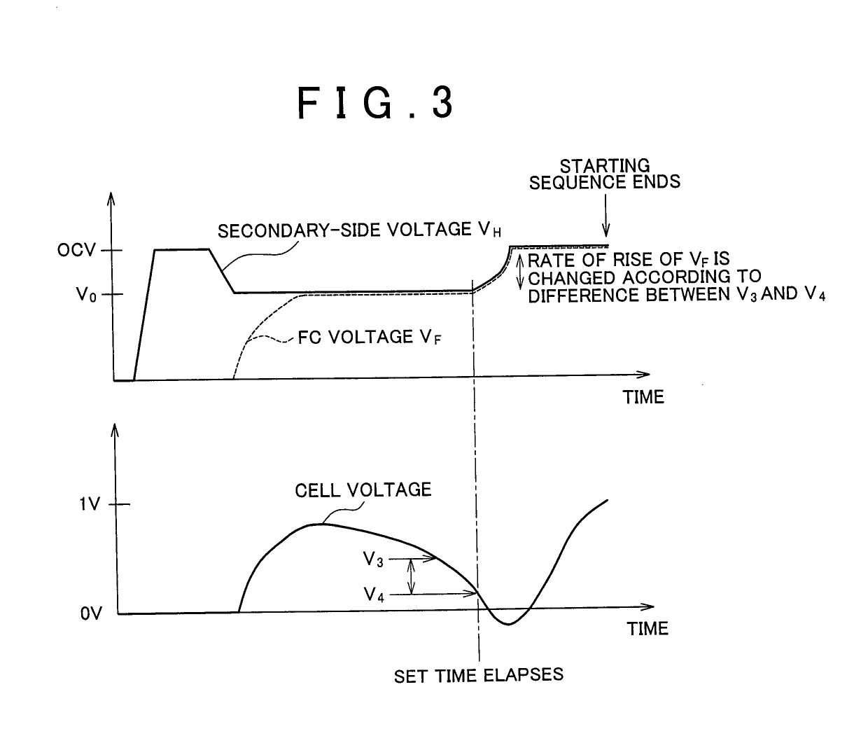

Next, another example of the operation of the fuel cell system 100 in accordance with the embodiment will be described. FIG. 3 is a diagram showing another example of the voltage control performed when the fuel cell system in accordance with the embodiment is started. In an upper section of FIG. 3, changes in the voltage of the fuel cell are shown; concretely, secondary-side voltage V_{H} that is the command voltage of the step-up/down voltage converter 13, and FC voltage V_{F} that is the voltage (total voltage) of the fuel cell 11 are shown. Besides, a lower section of FIG. 3 shows an example of changes in the voltage of a fuel unit cell in the case where the cell voltage thereof becomes low.

It is to be noted herein that in this example, the process during a period from when the electrochemical reaction between the hydrogen and the oxygen in the air begins within the fuel cell 11 to when the FC voltage V_{F} of the fuel cell 11 detected by the voltage sensor 43 rises from the starting voltage, is the same as the process described above.

After a certain time elapses after the FC voltage V_{F} of the fuel cell 11 has risen, the control portion 50 determines whether or not the cell voltage (V₄) of the fuel unit cell detected by the voltage sensor 43 is lower than or equal to a certain voltage (V₃) that is pre-set in the control portion 50. If the cell voltage (V₄) of the fuel unit cell is lower than or equal to the certain voltage (V₃), the control portion 50 finds a difference between the certain voltage and the low cell voltage of the fuel unit cell. Then, for example, using a control map in which a relation between the difference between the certain voltage and the cell voltage, and the rate of rise of the secondary-side voltage V_{H} is presented, the control portion 50 raises the secondary-side voltage V_{H} according to the found difference so as to raise the FC voltage V_{F} of the fuel cell 11 above the high-potential-avoiding voltage V₀ (the upper limit of this raising is the open-circuit voltage OCV). It suffices that the certain voltage (V₃) is appropriately set.

As stated above, the fuel cell 11 has a characteristic that as the FC voltage V_{F} rises to the open-circuit voltage OCV, the output current of the fuel cell 11 gradually decreases, and that when the FC voltage V_{F} reaches the open-circuit voltage OCV, the output current of the fuel cell 11 becomes zero. In this embodiment, if the difference between the cell voltage of a fuel unit cell and the certain voltage is large, the FC voltage V_{F} of the fuel cell 11 is correspondingly raised even more greatly (e.g., to the vicinity of the open-circuit voltage OCV) and therefore the output current of the fuel cell 11 is restricted, whereby the recovery of the cell voltage of the low-voltage fuel unit cell is attempted.

At the time of starting the fuel cell 11, the control portion 50 raises the FC voltage V_{F} of the fuel cell 11 above the high-potential-avoiding voltage V₀ according to the difference between the certain voltage and the cell voltage, and then shifts to ordinary operation after the elapse of a certain time, assuming that the starting of the fuel cell 11 has been completed, regardless of whether the fuel unit cell is recovered. Incidentally, this operation is not restrictive. For example, when the cell voltage of a low-voltage fuel unit cell becomes equal to or higher than the certain voltage (V₃), the control portion 50 may lower the FC voltage V_{F} of the fuel cell 11 to the high-potential-avoiding voltage V₀, and then may shift to ordinary operation, assuming that the starting of the fuel cell 11 has been completed.

On the other hand, if the cell voltage of a fuel unit cell is higher than or equal to the certain voltage (V₃), the control portion 50 determines that the fuel unit cell does not have abnormality, and shifts to ordinary operation, assuming that the starting of the fuel cell 11 has been completed.

As described above, in this embodiment, if a low voltage of a fuel unit cell occurs when the fuel cell is started, the voltage of the fuel cell is made higher than the high-potential-avoiding voltage, and therefore the output current of the fuel cell is restricted. Therefore, during the starting of the fuel cell, the low-voltage fuel unit cell can be recovered, and then ordinary operation can be entered. Consequently, the fuel cell system can be started without impairing the durability thereof.

While the invention has been described with reference to example embodiments thereof, it should be understood that the invention is not limited to the example embodiments or constructions. To the contrary, the invention is intended to cover various modifications and equivalent arrangements. In addition, while the various elements of the example embodiments are shown in various combinations and configurations, which are exemplary, other combinations and configurations, including more, less or only a single element, are also within the spirit and scope of the invention.

1. A fuel cell system comprising:
a fuel cell that has a plurality of fuel unit cells that generate electricity through an electrochemical reaction between a fuel gas and an oxidant gas; and a control portion that controls voltage of the fuel cell, and that has: a start portion that starts the fuel cell by raising the voltage of the fuel cell from a starting voltage to a high-potential-avoiding voltage that is lower than an open-circuit voltage; and a command portion that further raises the voltage of the fuel cell beyond the high-potential-avoiding voltage if cell voltage of at least one of the plurality of fuel unit cells is lower than or equal to a certain voltage after a certain time elapses after the voltage of the fuel cell is raised to the high-potential-avoiding voltage.

2. The fuel cell system according to claim 1, wherein the command portion raises the voltage of the fuel cell to the open-circuit voltage if the cell voltage of at least one of the plurality of fuel unit cells is lower than or equal to the certain voltage after the certain time elapses after the voltage of the fuel cell is raised to the high-potential-avoiding voltage.

3. The fuel cell system according to claim 1, wherein if the cell voltage of at least one fuel unit cell of the plurality of fuel unit cells is lower than or equal to the certain voltage after the certain time elapses after the voltage of the fuel cell is raised to the high-potential-avoiding voltage, the command portion raises the voltage of the fuel cell beyond the high-potential-avoiding voltage according to a difference between the certain voltage and the cell voltage of the at least one fuel unit cell.

4. An electric vehicle that is equipped with the fuel cell system according to claim 1.

5. A control method for a fuel cell system that includes a fuel cell that has a plurality of fuel unit cells that generate electricity through an electrochemical reaction between a fuel gas and an oxidant gas, comprising:
starting the fuel cell by raising voltage of the fuel cell from a starting voltage to a high-potential-avoiding voltage that is lower than an open-circuit voltage;
detecting cell voltage of the plurality of fuel unit cells after a certain time elapses after the voltage of the fuel cell is raised to the high-potential-avoiding voltage;
determining whether or not the detected cell voltage of at least one of the plurality of fuel unit cells is lower than or equal to a certain voltage; and
further raising the voltage of the fuel cell beyond the high-potential-avoiding voltage if it is determined that the cell voltage of at least one of the plurality of fuel unit cells is lower than or equal to the certain voltage.

6. The control method according to claim 5, wherein the voltage of the fuel cell is raised to an open-circuit voltage that is higher than the high-potential-avoiding voltage, if it is determined that the cell voltage of at least one of the plurality of fuel unit cells is lower than or equal to the certain voltage.

7. The control method according to claim 5, wherein if it is determined that the cell voltage of at least one fuel unit cell of the plurality of fuel unit cells is lower than or equal to the certain voltage, the voltage of the fuel cell is further raised beyond the high-potential-avoiding voltage according to a difference between the certain voltage and the cell voltage of the at least one fuel unit cell.
